(19) United States
(12) Patent Application Publication
(10) Pub. No.: US 2022/0237727 A1
(43) Pub. Date: Jul. 28, 2022

(54) SYSTEM AND METHOD FOR PERFORMING LEGAL BACKGROUND CHECKS

(71) Applicant: A.M.S. INFORM PRIVATE LIMITED, Gautam Buddha Nagar (IN)

(72) Inventor: Sachin Aggarwal, Gautam Buddha Nagar (IN)

(21) Appl. No.: 17/693,296

(22) Filed: Mar. 11, 2022

Related U.S. Application Data
(63) Continuation-in-part of application No. 16/923,430, filed on Jul. 8, 2020.

(30) Foreign Application Priority Data
Jul. 8, 2019 (IN) 201911027271

(51) Int. Cl. G06Q 50/26; G06F 16/34; G06V 40/16

(52) U.S. Cl. CPC G06Q 50/265; G06V 40/172; G06F 16/345

(57) ABSTRACT

There is disclosed a system for performing legal background checks of at least one individual including a server arrangement that is coupled to an e-court database, an act information database and a user interface for at least one client. The server arrangement receives at least one image and bibliographic information of the at least one individual from the at least one client using the user interface, extracts one or more features of the received image, retrieves information from the e-court database using the extracted one or more features of the received image and the bibliographic information of the at least one individual, generates a match score for the retrieved information, identifies at least one relevant section of the act information database using the retrieved information, determines a type of legal matter related to the at least one individual and generates a legal background check report of the at least one individual.

### TECHNICAL FIELD

The present disclosure relates generally to background checks and verification of an individual; and more specifically, to systems for performing legal background checks of individuals. Furthermore, the present disclosure also relates to methods of performing legal background checks of individuals.

### BACKGROUND

There are a number of situations, where people interact with one another, and one of the interacting parties must make a decision as to whether or not to partner with or otherwise “engage” another party. The background screening is one of the most reliable indicators when it comes to determining the attitude and character of a person/party of interest. Legal background checks are also conducted for legitimate investigative purposes that are not regulated by the judiciary.

Typically, the legal background checks are used to ensure that the person of interest do not have any disqualifying event or any legal matter in any of his/her prior engagement. Traditionally, legal background checks are time consuming and require a lot of paperwork.

Typically, most relevant information about a particular party is learned through face-to-face interaction or indirect communication. Other important information, however, such as criminal background, financial instability, and invalidity of certain representations is generally not readily communicated by the person of interest.

Most private sector criminal history background checks re conducted by “consumer reporting agencies” (typically background screening companies) using the applicant's name and date of birth to search commercial databases and state and local government archives of criminal history records.

With most conventional legal background check services are expensive and time-consuming process. Moreover, there may be a reasonable explanation as to why the negative information exists, thereby exonerating the individual and allowing their status as a viable candidate to remain intact.

Other problems remain as well. For instance, despite all the advances associated with online information, the various public and private databases do not necessarily collaborate with each other. Thus, conventional systems are not instantaneous, in that multiple databases must be searched. In addition, the engaging party typically bears the cost for the screening process, putting an inordinate expense on that party, rather than distributing fair shares of that expense among each of the individuals. This expense to the engaging party is increased when a second background check is performed to prevent engaging on stale data.

Accordingly, when a background check is performed using the fraudulent name, no information regarding the actual individual applying for the position is uncovered. Therefore, any relevant information such as criminal convictions, etc. regarding the actual individual applying for the position remains unknown. A similar problem has recently received a lot of attention in the media with criminals using fraudulent identities to obtain individuals' personal information from data aggregators and subsequently stealing the individuals' identities.

Therefore, there exist a need of processes that allows client to obtain the background check report with all relevant details and explanations, in real-time manner.

### SUMMARY

An object of the present disclosure is to provide a system for performing legal background checks of individuals. Another object of the present disclosure is to provide a method of (for) performing legal background checks of individuals.

The present disclosure seeks to provide a solution to the existing problem of inaccurate, time consuming and expensive legal background checks. Moreover, the present disclosure seeks to provide a solution to the existing problem of determining accurate interpretation of the legal matters included in the background check reports. An aim of the present disclosure is to provide a solution that overcomes at least partially the problems encountered in prior art, and provides a system that enables a client to obtain an unbiased Legal background check report of an individual or a party in real-time manner.

In an aspect, embodiments of the present disclosure seeks to provide a system for performing legal background checks of at least one individual, wherein the system includes a server arrangement that is coupled to an e-court database, an act information database and a user interface for at least one client, characterized in that the server arrangement (in operations):
receives at least one image and bibliographic information of the at least one individual from the at least one client using the user interface;
extracts one or more features of the received image;
retrieves information from the e-court database using the extracted one or more features of the received image and/or the bibliographic information of the at least one individual;
generates a match score for the retrieved information;
identifies at least one relevant section of the act information database using the retrieved information;
determines a type of legal matter related to the at least one individual; and
generates a legal background check report of the at least one individual.

In another aspect, embodiments of the present disclosure seeks to provide a method of (for) performing legal background checks of at least one individual, wherein the method comprises:
receiving at least one image and bibliographic information of at least one individual from at least one client using a user interface;
extracting one or more features of the received image;
retrieving information from an e-court database by using the extracted one or more features of the received image and/or the bibliographic information of the at least one individual;
generating a match score for the retrieved information;
identifying at least one relevant section of an act information database using the retrieved information;
determining a type of legal matter related to the at least one individual; and
generating a legal background check report of the at least one individual.

Embodiments of the present disclosure substantially eliminate or at least partially address the aforementioned problems in the prior art, and enables the aforesaid system for performing legal background checks without involving any mediator or third person in a reliable, efficient and real time manner. Furthermore, the system provides transparency related to process of legal background check.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for performing legal background checks of at least one individual, in accordance with an embodiment of the present disclosure; and

FIG. 2 is a flow chart of method for performing legal background checks of at least one individual using the system of FIG. 1, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention relates to a system for performing legal background checks. The system may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove more convenient to construct more specialized apparatus to perform the required method steps. The required structure for a variety of these machines will appear from the description given.

In one aspect, the present disclosure seeks to provide a system for performing legal background checks of at least one individual, wherein the system includes a server arrangement that is coupled to an e-court database, an act information database and a user interface for at least one client, characterized in that the server arrangement (in operations):
receives at least one image and bibliographic information of the at least one individual from the at least one client using the user interface;
extracts one or more features of the received image;
retrieves information from the e-court database using the extracted one or more features of the received image and/or the bibliographic information of the at least one individual;
generates a match score for the retrieved information;
identifies at least one relevant section of the act information database using the retrieved information;
determines a type of legal matter related to the at least one individual; and
generates a legal background check report of the at least one individual.

In another aspect, the present disclosure seeks to provide a method of (for) performing legal background checks of at least one individual, wherein the method comprises:
receiving at least one image and bibliographic information of at least one individual from at least one client using a user interface;
extracting one or more features of the received image;
retrieving information from an e-court database by using the extracted one or more features of the received image and/or the bibliographic information of the at least one individual;
generating a match score for the retrieved information;
identifying at least one relevant section of an act information database using the retrieved information;
determining a type of legal matter related to the at least one individual; and
generating a legal background check report of the at least one individual.

The present disclosure provides the aforesaid system and the aforesaid method for performing legal background checks of at least one individual. Beneficially, the system provides a cost-effective and real-time solution for obtaining information of legal matters associated with an individual. Essentially, the system provides a platform to the client to obtain legal information associated with a person of interest in real-time and efficient manner.

It will be appreciated that the aforesaid system for performing legal background checks is not limited to a predefined number of the clients and the individuals. Moreover, the aforesaid system for performing legal background checks could be employed to perform a plurality of legal background checks simultaneously.

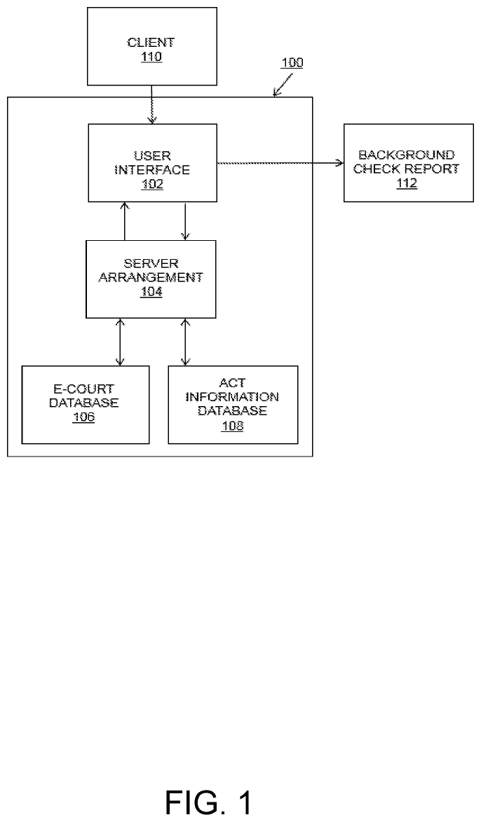

Now referring to FIG. 1, there is described is a block diagram of a system 100 for performing legal background checks of at least one individual, in accordance with an embodiment of the present disclosure. As shown, the system 100 includes a server arrangement 104, an e-court database 106, an act information database 108 and a user interface 102. The server arrangement 104 is communicably coupled to the e-court database 106, the act information database 108 and the user interface 102 for at least one client 110. The server arrangement 104, when in operation, receives bibliographic information of at least one individual from the at least one client 110 using the user interface 102, retrieves information from the e-court database 106 using the received bibliographic information of the at least one individual, generates a match score for the retrieved information, identifies at least one relevant section of the act information database 108 using the retrieved information, determines a type of legal matter related to the at least one individual and generates a legal background check report 112 of the at least one individual.

Throughout the present disclosure the term “server arrangement” relates to an arrangement of at least one server that, when operated, performs the aforementioned steps and generates the legal background check report 112. The term “server arrangement” generally refers to an application, program, process or device in a client-server relationship that responds to requests for information or services by another application, program, process or device (a client) on a communication network. The term “server arrangement” also encompasses software that makes the act of performing the legal background checks possible. The term “client” generally refers to an application, program, process or device in a client-server relationship that requests information or services from another application, program, process or device (the server) on the communication network. Importantly, the terms “client” and “server” are relative since an application may be a client to one application but a server to another application. The term “client” also encompasses software that makes the connection between a requesting application, program, process or device and a server possible, such as an FTP client.

Furthermore, the server arrangement 104 is communicably coupled to the e-court database 106, the act information database 108 and the user interface 102 for at least one client 110 using a communication network. It will be appreciated that the communication network can be an individual network, or a collection of individual networks that are interconnected with each other to function as a single large network. The communication network may be wired, wireless, or a combination thereof. Examples of the individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, radio networks, telecommunication networks, and Worldwide Interoperability for Microwave Access (WiMAX) networks.

Throughout the present disclosure the term “processing unit” refers to a processor within a computer that carries out instructions of a computer program.

Throughout the present disclosure the term “client device” may include but not limited thereto a mobile communication device, laptop, computer and tablet.

Throughout the present disclosure the term “user interface” refers to a means by which a user and a computer system interact. Throughout the present disclosure, the server arrangement 104 is communicably coupled to a processing unit of a client device, wherein the client requests services though the user interface of the client device.

The server arrangement 104, when in operation, receives at least one image and bibliographic information of the at least one individual from the at least one client 110 using the user interface 102. The received image associated with the at least one individual defines the identity of the at least one individual. Further, the server arrangement 104, when in operation, extracts one or more features of the received image and retrieves information from the e-court database using the extracted one or more features of the received image and/or the received bibliographic information of the at least one individual. The server arrangement 104 thereafter generates a match score for the retrieved information. Furthermore, the server arrangement 104, when in operation, identifies at least one relevant section of the act information database using the retrieved information, determines a type of legal matter related to the at least one individual and generates the legal background check report 112 of the at least one individual.

In an embodiment, the bibliographic information may include the name and address of the at least one individual. Additionally, the bibliographic information may further include date of birth, father's name, mother's name, spouse's name and so forth.

In an embodiment, the server arrangement 104 is configured to generate a visual representation in the form a thumbnail from the received at least one image. The server arrangement 104 generates a visual representation of the received at least one image by extracting one or more features of the received at least one image. Furthermore, the extracted features are quantized thereafter to obtain a visual representation of the image. Herein, quantization is the process of constraining an input from a continuous or otherwise large set of values to a discrete set. The one or more extracted features of the received at least one image are converted into a discrete set in the process of quantization of the extracted one or more features of the received at least one image. In another embodiment, the one or more extracted features of said image comprises at least color(s), parts and/or patterns of an object in an image, histogram of the oriented gradient in an image, convolutional neural network and so forth. In an embodiment, the convolutional neural network (CNN) is concerned with a deep learning algorithm that takes in an input image, assign importance (learnable weights and biases) to various aspects/objects in the image and be able to differentiate one image from the other. CNNs use image recognition and classification in order to detect objects, recognize faces, etc. They are made up of neurons with learnable weights and biases. CNNs are primarily used to classify images, cluster them by similarities, and then perform object recognition. Other visual features may also be used additionally or alternatively.

The server arrangement 104 is configured to search the received at least one image in the e-court database and retrieve one or more images from the e-court database using the received at least one image of the at least one individual. The one or more images are searched in the e-court database using the extracted and/or the quantized features of the received at least one image. Furthermore, in another embodiment, the server arrangement 104 also retrieves other information as well such as name, address, gender and so forth pertaining to the at least one individual in response to the received at least one image.

In an embodiment of the present disclosure, the server arrangement 104 comprises an image detection module that employs a visual analysis algorithm comprising a substantially whole image classification algorithm and an object localization algorithm to analyze one or more images retrieved from the e-court database. The whole image visual classification algorithm analyzes the visual representation of an image to determine if the retrieved at least one image from the e-court database contains visual characteristics that resemble the visual characteristics or features of the at least one image associated with the at least one individual received from the client's user interface. Examples of such algorithms include but are not limited to Haar Cascade Detector and HOG Detector. Alternatively, other algorithms may also be suitable.

According to an embodiment of the present disclosure, the image detection module is also configured to generate at least a binary image from the received at least one image of the at least one individual. Furthermore, the image detection module converts the one or more images retrieved from the e-court database into the one or more binary images. In an embodiment, the image detection module compares the binary images of the at least one individual received from the client's user interface with the binary images generated from the retrieved one or more images from the e-court database. Advantageously, the analysis for a similar image is performed in a shorter period of time than when the analysis for an image is performed with the raw one or more images.

In accordance with another embodiment, the image detection module further comprises a “binarization specifying unit” that provides an extent of binarization. The binarization specification unit is configured to adjust a level of binarization in generating a binary image by binarization of the thumbnail image in the image detection module.

In an embodiment, the server arrangement 104 provides an image match score that is indicative of the extent of matching of any image retrieved from the e-court database with the image received from the client's user interface. It will be appreciated that only images that have a sufficiently high image match score of containing a visual feature as determined by whether they meet a minimum threshold value are received for further processing. Furthermore, the minimum threshold value for retrieving an image lies within the range of (90-92) %, (90-94) %, (90-96) %, (90-96) %, (90-98) %, (90-100) %.

In a further embodiment, in an event of exact matching of the image retrieved from the e-court database with the image received from the client's user interface, all the information in the e-court database is retrieved for further processing.

In an embodiment, the e-court database 106 may include but not limited to the information of a plurality of legal records including at least one of a police verification data; a criminal court data; a police clearance certificate data; and an online criminal verification data.

The term “police verification data” refers to legal records associated with different parties that are secured with local police station of respective jurisdiction.

The term “criminal court data” refers to legal records related to different individuals that are secured with District and High courts.

The term “Police clearance certificate data” refers to legal records related to different individuals that are secured with Police Commissioner Office/Superintendent of Police.

The term “online criminal verification data” refers to legal records related to different individuals that are secured with online database of District Courts and Proprietary Databases.

In an embodiment, the legal background check report 112 may include the bibliographic information of the at least one individual, the identified at least one relevant section, the match score and the determined type of legal matter related to the at least one individual. Herein, the generated match score is the aggregation of the image match score and the bibliographic information match score as described in the present disclosure. Optionally, the type of legal matter related to the at least one individual may include at least one of a civil and a criminal matter.

Throughout the present disclosure the term “legal matter” refers to an issue between two or more parties that requires legal consideration. Further, the term “civil matter” refers to a matter that involves a legal dispute between two or more parties. The civil action begins when a party to a dispute files a complaint and pays a filing fee required by statute. Furthermore, the term “criminal matter” refers to a matter that begins when a person suspected of a crime is indicted by a grand jury or otherwise charged with the offense by a government official called a prosecutor or district attorney.

In an embodiment, the match score may be generated based on the aggregation of the image match score and the bibliographic information match score, wherein the image match score indicates a level of matching of the received at least one image of at least one individual with the one or more images received from the e-court database. Similarly, the bibliographic information match score signifies a level of matching of the received bibliographic information with information present in the plurality of legal records of the e-court database.

In an exemplary embodiment, in an event of exact match of the image, name and the address of the at least on individual in the legal records of the at least one of the police verification data, the criminal court data, the police clearance certificate data and the online criminal verification data; the match score is 100.

In other exemplary embodiments, in the event of complete image match, partial name match and full address match the match score may range between 90-99. Similarly, in the event of complete image match, full name match and partial address match the match score may range between 90-99.

According to an embodiment of the present disclosure, the server arrangement 104 retrieves the bibliographic information and/or one or more images from the e-court database in response to the received bibliographic information and/or the at least one image of the at least one individual. The one or more features of said images are extracted by the server arrangement 104 and are further processed in accordance with the embodiments as described herein the present disclosure. In an embodiment, the one or more extracted features of the images retrieved from the e-court database are matched with the one or more extracted features of the at least one individual received from the client's user interface, so as to generate the image match score.

In accordance with an embodiment of the present disclosure, the server arrangement 104 comprises an image matching unit that is configured to compare the at least one image with the retrieved one or more images from the e-court database. Furthermore, the image match score is generated that indicative of the extent of matching of the received at least one image of the at least one individual with the one or more images retrieved from the e-court database.

In another embodiment, the server arrangement 104 comprises a bibliographic information matching unit that is responsible for comparing of the received bibliographic information of the at least one individual with the bibliographic information retrieved from the e-court database. Furthermore, the bibliographic information match score is generated that is indicative of the extent of matching of the received bibliographic information of the at least one individual with the bibliographic information retrieved from the e-court database.

In an embodiment, there may occur an event wherein the image retrieved from the e-court database is not exactly matched with the image received from the client's user interface. In an exemplary embodiment, the image retrieved from the e-court database is compared and the generated image match score only lies within the range of (90-92) %, (90-94) %, (90-96) %, (90-98) %, (90-99) %. In such an event, the server arrangement 104 ensures that the other retrieved bibliographic information from the e-court database will be exactly matched (100% bibliographic information match score). Herein, the other retrieved information may include name, address, gender, education and so forth of the at least one individual.

In another embodiment, there may occur the event in which the bibliographic information such as name, address, gender and so forth of an individual are not exactly matched with the information retrieved from the e-court database. In an example, the generated bibliographic information match score of the retrieved bibliographic information lies only in the range of (90-92) %, (90-94) %, (90-96) %, (90-98) %, (90-99) %. In such a case, the server arrangement 104 ensures that the one or more images retrieved the e-court database are exactly matched with the image received from the client's user interface. In an example, the image in the e-court database is matched with the image match score of 100%, matching with the at least one image of the at least one individual.

In the complex process of background verification, the identity of the individual is very critical and is required to be exactly matched so as to either exonerating the individual and allowing their status as a viable candidate to remain intact or reject the individual based on the background verification report. It will be appreciated that in view of the above-mentioned embodiments, the present disclosure retrieves the exact information from the e-court database, pertaining to the at least one individual. When the one or more images retrieved from the e-court database are not exactly matched with the received image of the at least one individual from the client's end, then the server arrangement 104 ensures that the bibliographic information such as name, address etc. of the individual are exactly matched.

In a further embodiment, in an event where the bibliographic information such as name, address etc. are not exactly matched, the server arrangement 104 ensures that the image searched and analyzed (to be retrieved) is exactly matched with the received image from the client's user interface. Because the identity of the individual is very critical and the image as well as the bibliographic information needs to be exactly matched, the invention as described herein ensures that there exists no ambiguity in the data retrieved from the e-court database. In other words, the image matching unit and bibliographic information matching unit works in conjunction so as to retrieve the precisely accurate matching information pertaining to the at least one individual.

In an embodiment, the term “precisely accurate” refers to the exact matching of the bibliographic information and/or retrieved at least one image from the e-court database with the information and/or image received from the client's end.

In an embodiment, the server arrangement 104, when in operation, may create a plurality of search stings by creating phonetic variant of the name of the at least one individual. Specifically, creating phonetic variant of the name of the at least one individual is advantageous in terms of providing additional searches in the e-court data base, thus retrieving additional legal records related to the at least one individual.

In another embodiment, the server arrangement 104 is configured to determine at least one relevant data element from the pool of data elements in the e-court database. The server arrangement 104 includes one or more routines or sets of instructions that are operable to analyse the data or information in the pool of data elements to determine at least one relevant data element of the at least one individual. For example, the server arrangement 104 may include a software algorithm to analyse the documents, text, metadata and so forth, associated with the data elements.

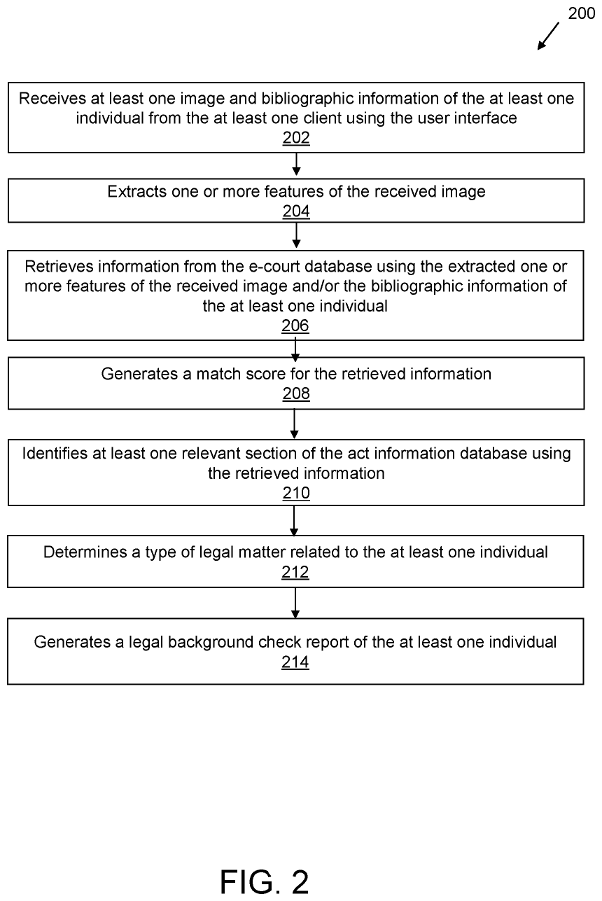

Now referring to FIG. 2, there is shown a flow chart of method 200 for performing legal background checks of at least one individual using the system (such as the system 100 of FIG. 1), in accordance with an embodiment of the present disclosure. As shown, the method 200 initiates at a step 202. In the step 202, the method 200 includes receiving bibliographic information of at least one individual from at least one client (such as the client 110 of FIG. 1) using a user interface (such as the user interface 102 of FIG. 1). In a second step 204, the method 200 includes retrieving information from an e-court database (such as the e-court database 106 of FIG. 1) by using the received bibliographic information of the at least one individual. In a third step 206, the method 200 includes generating a match score for the retrieved information. In a fourth step 208, the method 200 includes identifying at least one relevant section of an act information database (such as the act information database 108 of FIG. 1) using the retrieved information. In a fifth step 210, the method 200 includes determining a type of legal matter related to the at least one individual. In a sixth step 212, the method 200 includes generating a legal background check report (such as the legal background check report 112 of FIG. 1) of the at least one individual.

The steps 202 to 212 are only illustrative and other alternatives can also be provided where one or more steps are added, one or more steps are removed, or one or more steps are provided in a different sequence without departing from the scope of the claims herein.

In an embodiment, the method 200 may further include creating a plurality of search stings by creating phonetic variant of the name of the at least one individual. Specifically, creating phonetic variant of the name of the at least one individual is advantageous in terms of providing additional searches in the e-court data base, thus retrieving additional legal records related to the at least one individual.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A system for performing legal background checks of at least one individual, wherein the system includes a server arrangement that is coupled to an e-court database, an act information database and a user interface for at least one client, characterized in that the server arrangement (in operations):
receives at least one image and bibliographic information of the at least one individual from the at least one client using the user interface;
extracts one or more features of the received image;
retrieves information from the e-court database using the extracted one or more features of the received image and/or the bibliographic information of the at least one individual;
generates a match score for the retrieved information;
identifies at least one relevant section of the act information database using the retrieved information;
determines a type of legal matter related to the at least one individual; and
generates a legal background check report of the at least one individual.

2. A system of claim 1, wherein the bibliographic information includes a name and address of the at least one individual.

3. A system of claim 1, wherein the e-court database includes a plurality of legal records related to at least one of:
a police verification data;
a criminal court data;
a police clearance certificate data; and an online criminal verification data.

4. A system of claim 1, wherein the legal background check report includes the bibliographic information of the at least one individual, the identified at least one relevant section, the match score and the determined type of legal matter related to the at least one individual.

5. A system of claim 1, wherein the match score is generated based on a level of matching of the received bibliographic information with information present in the plurality of legal records of the e-court database.

6. A system of claim 1, wherein the determined legal matter includes at least one of a civil and a criminal matter.

7. A method of (for) performing legal background checks of at least one individual, wherein the method comprises:
receiving at least one image and bibliographic information of at least one individual from at least one client using a user interface;
extracting one or more features of the received image;
retrieving information from an e-court database by using the extracted one or more features of the received image and/or the bibliographic information of the at least one individual;
generating a match score for the retrieved information;
identifying at least one relevant section of an act information database using the retrieved information;
determining a type of legal matter related to the at least one individual; and
generating a legal background check report of the at least one individual.

8. A method of claim 7, wherein the bibliographic information includes a name and address of the at least one individual.

9. A method of claim 7, wherein the e-court database includes a plurality of legal records related to at least one of:
a police verification data;
a criminal court data;
a police clearance certificate data; and an online criminal verification data.

10. A method of claim 7, wherein the legal background check report includes the bibliographic information of the at least one individual, the identified at least one relevant section, the match score and the determined type of legal matter related to the at least one individual.

11. A method of claim 7, wherein the method further includes matching of the received bibliographic information with information present in the plurality of legal records of the e-court database, for generating the match score.

12. A method of claim 7, wherein the determined legal matter includes at least one of a civil and a criminal matter.
